(19) United States
(12) Patent Application Publication
(10) Pub. No.: US 2007/0078798 A1
(43) Pub. Date: Apr. 5, 2007

(54) Remote configuration and management of a franking machine

(76) Inventor: Lodovico Minnocci, Hamden, CT (US)

Correspondence Address: KENYON & KENYON LLP, 1500 K STREET N.W., SUITE 700, WASHINGTON, DC, 20005, US

(21) Appl. No.: 11/243,027

(22) Filed: Oct. 4, 2005

(51) Int. Cl. G06F 17/00

(52) U.S. Cl. 705/410

(57) ABSTRACT

A method of remotely accessing a meter includes issuing a meter identifier through a browser, utilizing an HTTP server to recognize the URL and run an application program, and reporting the results of running the application program to the browser.

### BACKGROUND OF THE INVENTION

The present invention relates to franking devices and in particular to remotely configuring and managing a device that produces indicia.

### BRIEF DESCRIPTION OF RELATED DEVELOPMENTS

A high volume postal customer may use a franking machine, also referred to as a meter, which incorporates a Postal Security Device (PSD) to secure the proof of payment of postal indicia. In an exemplary application, indicia may be applied to mailing items that identifies the value of the postage applied and other information. A customer may purchase postage and the purchased value may be stored in the PSD. As the postage indicia is applied to items, the value applied may be deducted from the stored value. Once postage indicia is applied, the item may then be dropped into the collection stream of the particular postal system and subsequently processed for delivery. U.S. Pat. No. 5,762,427, filed 25 Jan. 1996 discloses an exemplary franki9ng machine.

In various countries, for example the United States, postal meters may communicate with a remote data center to exchange information related to customer usage and funding for billing purposes and to have postage funds replenished. In the United States, a postal customer generally may add postage to the meter in two ways. The first is to physically take the meter to the postal authority, generally referred to herein as “the post,” where postage is purchased and added to the PSD. The second is to remotely add postage over a network, for example, a telephone line with a modem, or the Internet, where the added postage is deducted from an account usually maintained with a meter vendor or a trusted third party administrator, for example, a financial institution. In this case, customer or postal authority access to a meter's accounting system or memory system generally is not possible. Meters with this type of communication capability generally communicate with a data center in a postal service infrastructure where the meter initiates communication. U.S. Pat. No. 5,715,164 discloses an exemplary postal infrastructure system that provides for fund replenishment.

It would be advantageous to provide a user with the ability to remotely configure and manage a franking machine over a communication network.

### SUMMARY OF THE EXEMPLARY EMBODIMENTS

A method of remotely accessing a meter includes issuing a meter identifier through a browser, utilizing an HTTP server to recognize the URL and run an application program, and reporting the results of running the application program to the browser.

### BRIEF DESCRIPTION OF THE DRAWINGS

The foregoing aspects and other features of the disclosed embodiments are explained in the following description, taken in connection with the accompanying drawings, wherein:

FIG. 1 shows a block diagram of a system suitable for practicing the disclosed embodiments;

FIG. 2 shows a block diagram of meter according to the disclosed embodiments;

FIG. 3 shows the interaction between a user terminal and a meter according to the disclosed embodiments; and

FIG. 4 shows a diagram of a postage infrastructure data center.

### DETAILED DESCRIPTION OF THE PREFERRED EMBODIMENTS

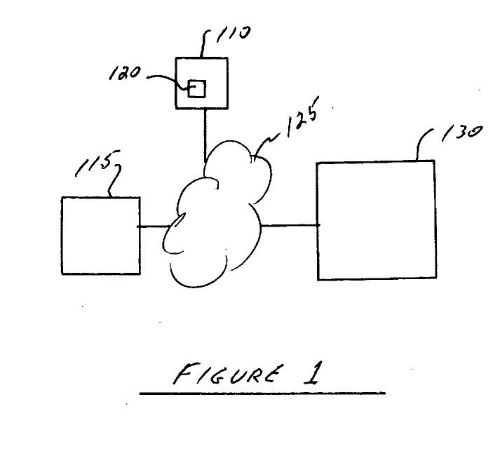

FIG. 1 shows a block diagram of a system 100 suitable for practicing the disclosed embodiments disclosed herein. Although the disclosed embodiments will be described with reference to the embodiment shown in the drawings, it should be understood that the disclosed embodiments can be embodied in many alternate forms of embodiments. In addition, any suitable size, shape or type of elements or materials could be used.

System 100 includes a user terminal 110, a funding device, shown in FIG. 1 as a meter 115, and a postal infrastructure data center 130 connected to the meter 115 through network 125.

It is a feature of the disclosed embodiments for a user to configure and manage the meter 115 through user terminal 110. The meter 115 may include a resident hypertext transfer protocol (HTTP) server. Various application programs may be accessed through the HTTP server to allow the user to configure and manage the meter 115. User terminal 110 may be a personal computer, a controller, or any device capable of communicating with an HTTP server.

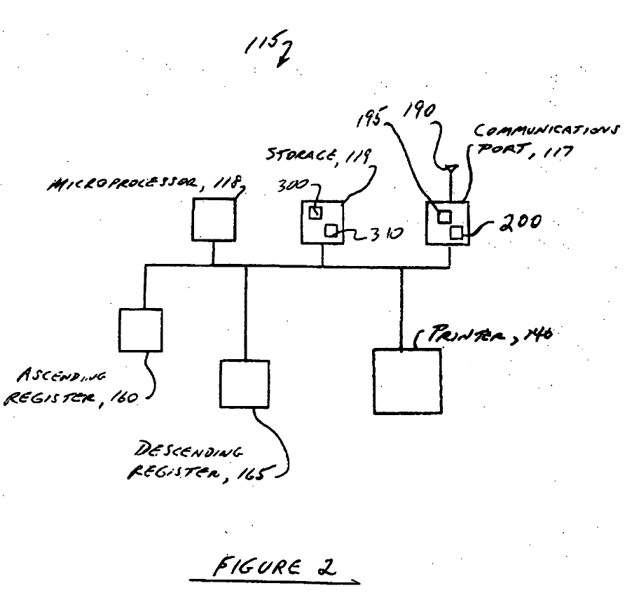

FIG. 2 shows a general block diagram of meter 115. Meter 115 may include a communications port 117 and a microprocessor 118 for performing electronic accounting functions, control functions, and franking functions according to programs stored in a storage device 119. Some of these functions or subsets of these functions may be grouped within a secure perimeter as what is commonly referred to as a Postal Security Device (PSD).

Storage device 119 generally stores machine readable program code which is adapted to cause microprocessor 118 to perform the functions of the disclosed embodiments. Storage device 119 may utilize optical, magnetic, semiconductor, electronic, or other types of suitable devices to store the program code.

Microprocessor 118 typically performs the electronic accounting functions in relation to franking items. Data associated with the accounting functions may include an accumulated total value of credit entered into the PSD, an accumulated total value of charges dispensed by the PSD by franking items, a count of the number of items franked, and a count of the number of items franked with a charge in excess of a predetermined value. The accumulated total value of credit may be stored in an ascending credit register 160, the accumulated total value of postage charges dispensed may be stored in a descending register 165, and the count of items may be stored in an items count register 170. The various registers may be located in storage device 119.

The franking functions performed by microprocessor 118 typically include providing an indication, funds, or other authorization to produce indicia, and reporting the number of items, value marked and other parameters to the accounting functions. Such indication, funds, or other authorization are referred to herein as indicia services.

The meter 115 generally provides indicia services locally utilizing a printer 140 and may be capable of franking a label, directly franking a mail piece, or franking any other suitable substrate. In one embodiment, meter 115 may be portable in that a user may place meter 115 in a specific location on or over a substrate and frank or print an object. Meter 115 may be capable of printing stamps, barcodes, addresses, planet codes, images, text, indicia, logos, graphics, or any other printable item in any desired order. For example, the user may be able to position meter 115 to print a return address, and then position meter 115 to print a mailing address, and then to print postage. In another embodiment, the meter 115 may remain stationary and printer 140 may be movable.

The printer 140 may be capable of printing on any suitable substrate or media, including an adhesive or tacky substrate, and may also be capable of applying a covering over the printed items. For example, the printer 140 may be capable of applying a film or coating over a printed item for protection or to prevent tampering.

The printer 140 may be an inkjet, dye sublimation, thermal wax, laser, electrostatic, xerographic, thermal, RF, or any suitable type of printer. In one embodiment, printer 140 may utilize energy beams, having high or low power, for example, RF beams, to print directly onto a substrate.

The control functions performed by microprocessor 118 may include utilizing communications port 117 to communicate with the postal infrastructure data center 130. Communications port 117 generally includes an antenna 190 and support circuitry 195 or other signaling devices 200 for communicating with the postal infrastructure data center 130 through the network 125.

The signaling devices 200 may provide an air interface, a wired interface, a wireless interface, or an electrical, electromagnetic, radio, infrared, or other suitable facility for communication. The support circuitry 195 may also include location determining circuitry, for example, a GPS facility for determining the location of the meter 115.

In one embodiment, the control functions performed by microprocessor 118 under control of the programs in storage device 119 may include implementation of an HTTP server 300 such that a user may communicate with the meter 115 using a web browser 120 running on the user terminal 110 (FIG. 1). The programs in storage device 119 may also include application programs 310 accessible by the HTTP server 300. Application programs 310 may include diagnostics, feature management functions, configuration functions, data retrieval functions, and any other meter configuration or management functions.

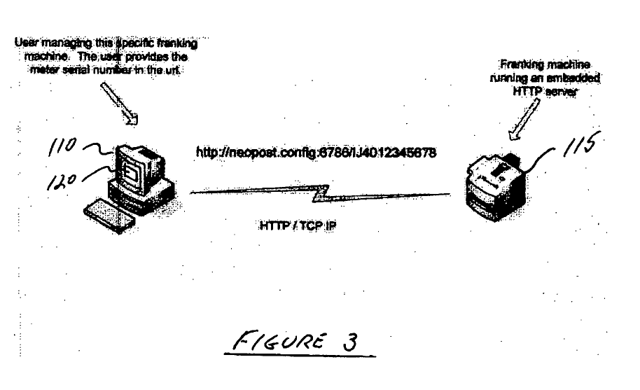

Referring to FIG. 3, in operation, the user initiates a browser 120 at the user terminal 110. The user addresses the meter 115 by including a meter identifier, for example, the meter serial number, in a URL in the browser 120. The HTTP server recognizes the meter identifier as identifying the meter 115 and may run one or more application programs 310 in response.

For example, upon recognizing the URL, the HTTP server may run an application program that present a menu of various applications and queries to the user terminal 110 for selection by the user. The applications may include programs that add additional services, run and report diagnostics, update data tables, replenish funds, etc. The queries may include requests for data, operational parameters, etc. Upon presentation of the menu, the user may select one of the applications or queries and the HTTP server may then run the corresponding application or query and return the result to the user terminal.

In another embodiment, the application or query may be specified in the URL along with the meter identifier and the meter may respond with the result of the application or query.

The postal infrastructure data center 130 generally has the capability to access the meter 115 to exchange information as required. For example, the postal infrastructure data center 130 may access meter 115 to download additional features, updates, upgrades, programs, diagnostic functions, delivery confirmation or other types of information. The postal infrastructure data center 130 may access meter 115 to retrieve information including accounting data, status data, etc.

Postal infrastructure data center 130 may initiate a data exchange by initially detecting the communications network 125 and establishing a connection. Communication network 125 may include any suitable communications network, for example, the Public Switched Telephone Network (PSTN), a wireless network, a wired network, a Local Area Network (LAN), a Wide Area Network (WAN), virtual private network (VPN), an air interface, etc. The air interface may include any suitable wireless communication protocols or signaling techniques or standards, for example TDMA, CDMA, IEEE 802.11, Bluetooth, close range RF, optical, any appropriate satellite communication standards, etc.

After postal infrastructure data center 130 has established a connection with the communication network 125, postal infrastructure data center 130 may then attempt to logon or establish a connection to meter 115.

Postal infrastructure data center 130 may be capable of establishing more that one connection to meter 115 simultaneously. For example, postal infrastructure data center 130 may establish a first connection to meter 115 for fund replenishment and, during the first connection, may establish a second connection to the meter 115 to download data tables.

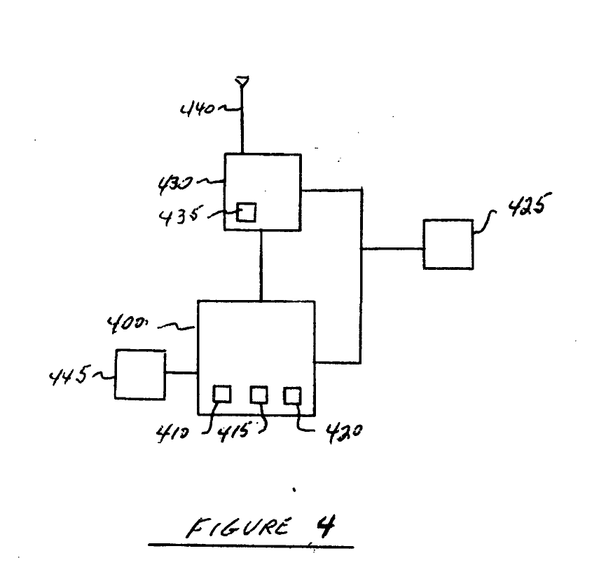

Referring to FIG. 4, the postal infrastructure data center 130 may generally include a server 400, several data bases 410, 415, 420, a power facility 425, for example, a power distribution network, and communication circuitry 430. Communication circuitry 430 may include an antenna 440 and other circuitry and devices 435 for communication with meters 115₁ . . . 115ₙ through the one or more networks 125₁ . . . 125ₙ.

In other embodiments, devices 435 may include suitable circuitry, programs, transmitters and receivers for any appropriate type of wireless communication utilizing radio frequency (RF), infrared (IR), optical, acoustical, any type of electromagnetic based technology, or any other type of wireless communication. The postal infrastructure data center 130 may also include a user interface facility 445 which may provide local users with access to postal infrastructure data center services.

It should be understood that the foregoing description is only illustrative of the disclosed embodiments. Various alternatives and modifications can be devised by those skilled in the art without departing from the disclosed embodiments. Accordingly, the disclosed embodiments is intended to embrace all such alternatives, modifications and variances which fall within the scope of the appended claims.

What is claimed is:

1. A method of remotely accessing a meter comprising:
issuing a meter identifier through a browser;
utilizing an HTTP server to recognize the URL and run an application program; and
reporting the results of running the application program to the browser.
